(19) United States
(12) Patent Application Publication
(10) Pub. No.: US 2009/0158202 A1
(43) Pub. Date: Jun. 18, 2009

(54) INFORMATION PROCESSING METHOD, INFORMATION PROCESSING SYSTEM AND DISPLAY CONTROL DEVICE

(75) Inventors: Hideki MATSUDA, Fujimi (JP); Junji AJIOKA, New York, NY (US); Minoru YOSHIMURA, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/332,422

(22) Filed: Dec. 11, 2008

(30) Foreign Application Priority Data
Dec. 14, 2007 (JP) 2007-323631

(51) Int. Cl. G06F 3/048

(52) U.S. Cl. 715/781

(57) ABSTRACT

An information processing method includes the steps of generating additional information associated with a predetermined position in a content to be displayed, storing content data indicating the content, specifying the position in the content, which is associated with the additional information, displaying the content indicated by the stored content data, controlling display so that a display area including the specified position is displayed in preference to other display areas in the display of the content, adding an additional image which is an image different from the content, and which is displayed by being associated with a certain position in the content, and performing update of the additional information, which is the update of allowing information indicating the added additional image and the position associated with the additional image to be included in the additional information.

### BACKGROUND

1. Technical Field

The present invention relates to display control when displaying contents.

2. Related Art

There is a technique of displaying a certain specific content preferentially to prompt confirmation. For example, in JP-A-2005-316925 (Patent Document 1), a technique of displaying a necessary message preferentially by performing so-called pop-up display is described.

However, in the technique described in Patent Document 1, it is not clear which part of the content is requested to be confirmed. In such technique, when the amount of the content is enormous, disadvantage occurs. Furthermore, in the technique described in Patent Document 1, a case in which the same content is exchanged between a certain user and another user several times, a case in which the content is circulated to plural users and some other cases are not considered.

### SUMMARY

An advantage of some aspects of the invention is to realize confirmation of contents by a user easily as compared with related art.

An information processing system according to an aspect of the invention includes a generating unit that generates additional information associated with a predetermined position in a content to be displayed, a storage unit that stores content data indicating the content, a specifying unit that specifies the position in the content, which is associated with the additional information generated by the generating unit, a display unit that displays the content indicated by the content data stored in the storage unit, a display control unit that controls display by the display unit so that a display area including the position specified by the specifying unit is displayed in preference to other display areas in the display of the content, an adding unit that adds an additional image which is an image different from the content, and which is displayed by being associated with a certain position in the content, and an update unit that performs update of the additional information generated by the generating unit and that allows information indicating the additional image added by the adding unit and the position associated with the additional image to be included in the additional information.

According to the information processing system, it is possible to designate a desired position in the content by the additional information, to display the designated position preferentially, to add an additional image at a desired position in the content and to update additional information so as to include the additional image, which enables confirmation of the content to be easy.

In the information processing system according to an aspect of the invention, the display control unit can apply a configuration in which the additional image is displayed with the display area when there is the additional image associated with the position in the case that the display area including the position specified by the specifying unit is displayed on the display unit. According to the configuration, it is possible to confirm the additional image added to the content when the content is displayed.

Additionally, a configuration in which an acceptance unit that accepts a handwriting image by a handwriting operation by a user is provided and the adding unit adds the handwriting image received by the reception unit as the additional image can be applied. According to the configuration, it is possible to add the handwriting image by the handwriting operation to the content and to confirm the image.

An information processing system according to an aspect of the invention can apply a configuration in which a first device and a second device are included, in which the first device has the generating unit and an output unit that outputs additional information generated by the generating unit and in which the second device has an acquisition unit that acquires additional information outputted by the output unit, the storage unit, the specifying unit, the display unit, the display control unit, the adding unit and the update unit. According to the configuration, it is possible to designate a position desired by a user of the first device, to allow a user of the second device to confirm the position and to perform additional description by the additional image.

An information processing system according to an aspect of the invention can apply a configuration in which a selection unit that select a link image displayed on the display unit is included, in which the display control unit displays the link image indicating a position specified by the specifying unit on the display unit and displays a display area including the position on the display unit in preference to other display areas when the link image is selected by the selection unit. According to the configuration, it is possible to preferentially display the position corresponding to the link image, taking the selection of the link image as a trigger, and for example, when there are plural designated positions, it is possible to display a desired position preferentially.

In the information processing system according to the aspect of the invention, the display control unit can apply a configuration in which a determination unit that determines whether preferential display based on the additional information is performed or not is included, in which the display control unit controls the display unit so that a display area including a position specified by the specifying unit is displayed in preference to other display areas in the display of the content when it is determined that the preferential display is performed. According to the configuration, it is possible to selectively perform display of giving preference to the designated position and the display different from such preferential display.

An information processing system according to an aspect of the invention can apply a configuration in which, in the case that there are plural positions specified by the specifying unit, when a position allowed to be included in the additional information by the update unit in the plural positions in the case of displaying the additional image, a display area including the position is displayed in preference to other display areas. According to the configuration, it is possible to confirm only a position which has been newly added in positions associated with the additional information.

An information processing system according to an aspect of the invention can apply a configuration in which a transmission unit that transmits additional information updated by the update unit to an external device is included. According to the configuration, it is possible to perform confirmation work of the content in cooperation with a user of the external device.

In such configuration, a configuration can be applied, in which the transmission unit performs transmission in accordance with destination information associated with the additional information and specifying the external device to which the information is transmitted. According to the configuration, it is possible to transmit additional information, taking a user who should perform confirmation next as a destination.

An information processing system according to an aspect of the invention can apply a configuration in which a user identifying unit that identifies a user relating to use is included, and in which the display control unit, when the user identified by the user identifying unit is a prescribed user, displays a display area including the position specified by the specifying unit in preference to other display areas in the display of the content, and when the user identified by the user identifying unit is not the prescribed user, displays the content on the display unit in a manner different from the case that the user is the prescribed user. According to the configuration, even when the user performing confirmation of the designated position and another user (for example, a user who designates the position to be confirmed) operate the same device, the display according to respective users can be performed.

A display control device according to an aspect of the invention includes a first acquisition unit that acquires content data indicating a content to be displayed, a second acquisition unit that acquires additional information associated with a predetermined position in the content, a specifying unit that specifies the position in the content, which is associated with additional information acquired by the second acquisition unit, a display control unit that displays the content indicated by the content data acquired by the first acquisition unit on the display unit, and that controls the display so that a display area including the position specified by the specifying unit is displayed in preference to other display areas in the display of the content, an adding unit that adds an additional image which is an image different from the content, and which is displayed by being associated with a certain position in the content, and an update unit that performs update of the additional information acquired by the second acquisition unit, and which performs the update of allowing information indicating the additional image added by the adding unit and the position associated with the additional image to be included in the additional information.

A program according to an aspect of the invention makes a computer function as a first acquisition unit that acquires content data indicating a content to be displayed, a second acquisition unit that acquires additional information associated with a predetermined position in the content, a specifying unit that specifies the position in the content, which is associated with additional information acquired by the second acquisition unit, a display control unit that displays the content indicated by the content data acquired by the first acquisition unit on the display unit, and that controls the display so that a display area including the position specified by the specifying unit is displayed in preference to other display areas in the display of the content, an adding unit that adds an additional image which is an image different from the content, and which is displayed by being associated with a certain position in the content, and an update unit that performs update of the additional information acquired by the second acquisition unit, which performs the update of allowing information indicating the additional image added by the adding unit and the position associated with the additional image to be included in the additional information.

### BRIEF DESCRIPTION OF THE DRAWINGS

The invention will be described with reference to the accompanying drawings, wherein like numbers reference like elements.

FIG. 1 is a view showing a configuration of an information processing system according to an embodiment of the invention.

FIG. 2 is a block diagram showing a configuration of a display terminal.

FIG. 3 is a flowchart showing operations performed by the display terminal.

FIG. 4 is a flowchart showing operations performed by the display terminal.

FIG. 5 is a flowchart showing operations performed by the display terminal.

FIG. 6 is a flowchart showing operations performed by the display terminal.

FIG. 7 is a flowchart showing operations performed by the display terminal.

FIG. 8 is a view illustrating display of a link image.

FIG. 9A and FIG. 9B are views illustrating modes of displaying both a content and an additional image.

### DESCRIPTION OF EXEMPLARY EMBODIMENTS

### First Embodiment

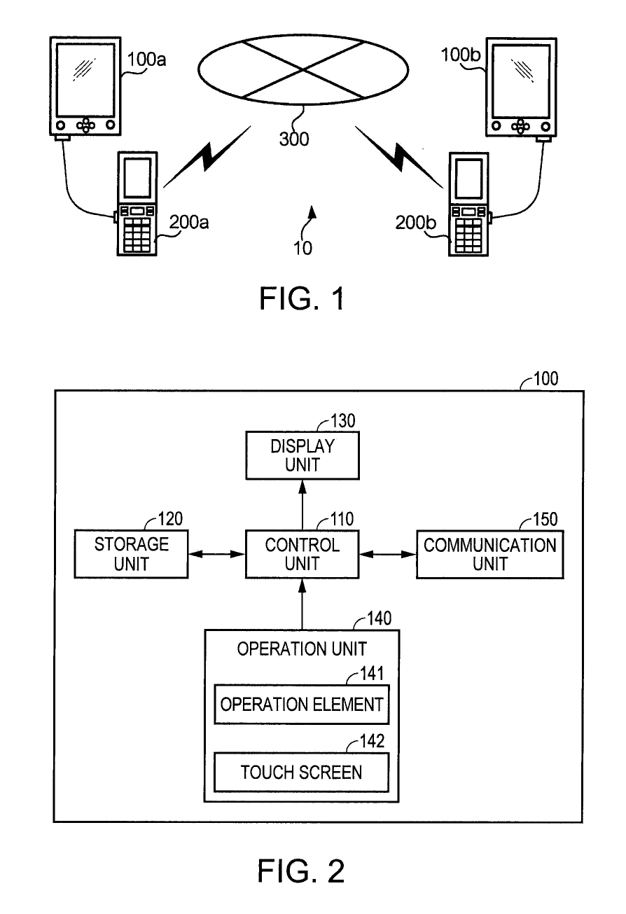

FIG. 1 is a view showing a configuration of an information processing system according to an embodiment of the invention. As shown in the drawing, an information processing system 10 according to an embodiment of the invention includes display terminals 100a, 100b, communication terminals 200a, 200b and a network 300. The display terminals 100a, 100b are portable display devices, which are so-called electronic papers. The display terminal 100a corresponds to an example of “first device” in the invention and the display terminal 100b corresponds to an example of “second device” in the invention. Each of the display terminals 100a, 100b includes a battery such as a secondary battery, operating by receiving power supply from the battery. The communication terminals 200a, 200b are portable communication devices, which are so-called cellular phone devices or smart phones. Each of the communication terminals 200a, 200b is connected to the display terminal 100a or the display terminal 100b respectively, realizing data communication complying with a prescribed system between them. The network 300 is a network for performing data communication between the communication terminal 200a and the communication terminal 200b. The network 300 performs data communication in a system with which the communication terminals 200a, 200b comply, which is, for example, a mobile communication network or Internet in the embodiment.

In the embodiment, the display terminal 100a and the communication terminal 200a are used by a certain user (hereinafter, referred to as a user “a”), and the display terminal 100b and the communication terminal 200b are used by a user different from the user “a” (hereinafter, referred to as a user “b”). The display terminal 100a and the display terminal 100b have the same configuration and the communication terminal 200a and the communication terminal 200b are also the same. In the following description, when it is not necessary to discriminate the display terminal 100a from the display terminal 100b, they are generically named “display terminal 100”, and when it is not necessary to discriminate the communication terminal 200a from the communication terminal 200b, they are generically named “communication terminal 200”.

FIG. 2 is a block diagram showing a configuration of the display terminal 100. As shown in the drawing, the display terminal 100 includes a control unit 110, a storage unit 120, a display unit 130, an operation unit 140 and a communication unit 150. The control unit 110 includes an computing device such as a CPU (Central Processing Unit) and volatile or non-volatile various memories, controlling operations of the whole display terminal 100 by executing programs stored in the storage unit 120 or memories. The storage unit 120 includes a storage medium such as a flash memory, storing data. It is preferable that the storage medium included in the storage unit 120 is formed to be detachable from the display terminal 100 such as a so-called memory card. The data stored in the storage unit 120 includes content data and additional information which are described later.

The display unit 130 displays images in accordance with content data. The images displayed by the display unit 130 include signs such as characters and numerals. The display unit 130 has a display surface including a prescribed display body and a drive circuit which drives the display body, performing display and rewrite of images. As the display body constituting the display unit 130, for example, a long-memory display body can be used. In this case, the long-memory display body is a display body which includes a so-called long-memory (or bistability) and which can maintain the tone even when voltage is not applied, for example, a microcapsule-type electrophoretic display body, a cholesteric liquid crystal display body and the like can be cited. The long-memory display body is a display body whose power consumption is generally lower than the other display bodies and which is suitable to be applied to the portable display terminal 100 as in the present embodiment.

The operation unit 140 is an interface which accepts operations by a user. The operation unit 140 includes operation elements 141 such as bottoms or switches and a touch screen 142, supplying operation information in accordance with the received operation to the control unit 110. As the operation elements 141, there are a switch for turning on/off the power, a button for moving a cursor displayed on the display unit 130, a button for rewriting display on the display unit 130 and the like. The rewrite of the display can be realized by so-called scroll display or realized by being switched in a predetermined unit (for example, in a unit of page). The touch screen 142 includes a planar screen provided so as to cover the display surface of the display unit 130, detecting touches at respective positions of the screen. The touch screen 142 supplies operation information indicating positions where touches have been detected to the control unit 110. The user performs touching operation by using a pen-like instrument or a finger.

The touch screen 142 can output operation information indicating temporal change (namely, traces) of positions where the touches have been detected. The traces represent the input by handwriting operation of a user, which are dots, lines, or signs. In the following description, the input contents indicated by the operation information by the handwriting operation of the user are referred to as a “handwriting image”.

The communication unit 150 is an interface for performing data communication with respect to the communication terminal 200. The communication unit 150 is connected to the communication terminal 200 by cables or by wireless, transmitting and receiving data. The communication unit 150 is connected to the communication terminal 200 by, for example, Bluetooth (registered trademark) or USB (Universal Serial Bus).

The configuration of the information processing system 10 according to the embodiment is described as follows. The display terminal 100 displays contents in accordance with content data. In the embodiment, the content is information to be displayed, which is, for example, a document including characters and images.

In the information processing system 10, respective users can confirm the same content in respective display terminals 100. In this case, the display terminals 100 of respective users store content data indicating the same content. The content data can be transmitted from one display terminal 100 to the other display terminal 100 or the data can be stored in both display terminals 100 in advance.

The display terminal 100 according to the embodiment has a function of designating a position which is requested to be confirmed by the user of the other party in the content and allowing the designated position to be displayed in preference to the other positions. The display terminal 100 also has a function of adding an image to be displayed with the content and allows the user of the other party to confirm the image. The image which can be added by the display terminal 100 include the above described handwriting image.

Operations executed by the display terminal 100 in the information processing system 10 according to the embodiment will be explained below. Here, a case in which, after the user “a” requested the user “b” to confirm a certain content, the user “b” confirms the content in response to the request and adds a handwriting image and the like at a necessary position, then, the user “a” reconfirms the content to which the handwriting image and the like are added is explained. In this case, the content is a document having plural pages and the display unit 130 displays the document part by part. That is, rewrite is necessary for displaying the whole content by the display unit 130. A display area which can be displayed at a time by the display unit 130 may be one page of the content, plural pages or half of a page.

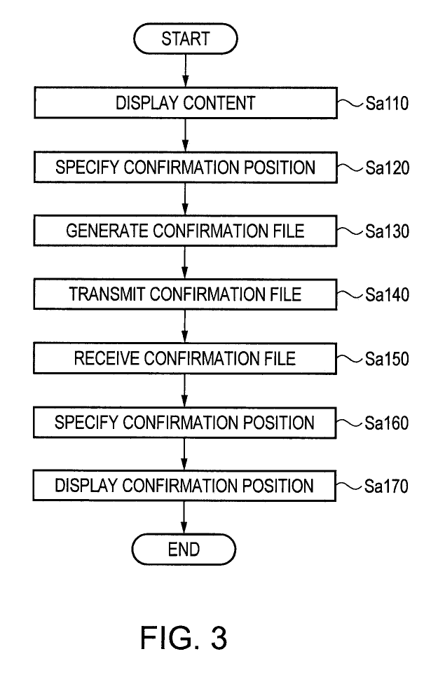

FIG. 3 is a flowchart showing operations performed by the display terminal 100a of the user “a”. The operations are realized by the control unit 110 of the display terminal 100a executing a prescribed program. As shown in the drawing, first, the display terminal 100a reads content data desired by the user “a”, displaying the corresponding content on the display unit 130 (Step Sa110). The user “a” performs operation of designating a position requested to be confirmed by the user “b” while browsing the content. The display terminal 100a accepts the operation and specifies the position designated by the user “a” (Step Sa120). The position specified in the step is referred to as a “confirmation position” in the following description.

The operation of designating the confirmation position may be performed, for example, in a unit of page or may be performed in a unit of prescribed section (paragraph, chapter and the like) provided in the document. It is not limited to the prescribed unit but it is preferable that a desirable position in the document can be designated and the position is specified by coordinates and the like. In short, the confirmation position designated by the user is an arbitrary position of the document, namely, the content.

The operation may be realized by providing a dedicated operation element 141 in the operation unit 140 or may be realized by operating the touch screen 142.

The display terminal 100a, when specifying the confirmation position designated by the user “a”, generates data in which the confirmation position is described (Step Sa130). The data is referred to as a “confirmation file” in the following description. The confirmation file is an example of “additional information” in an embodiment of the invention. The display terminal 100a generates a confirmation file which can identify respective confirmation positions when the user “a” designates plural positions. In the confirmation file, information such as pages, coordinates and the like for specifying confirmation positions designated by the user “a” is described by being associated with respective positions.

The user “a” performs a prescribed operation when completing the operation of designating the confirmation position. The operation corresponds to an instruction of transmitting the confirmation file to the display terminal 100b, and for example, and the operation is performed by operating the operation element 141. The display terminal 100a, when acquiring operation information indicating the operation, outputs the confirmation file through the communication unit 150 and transmits the file to the display terminal 100b (Step Sa140).

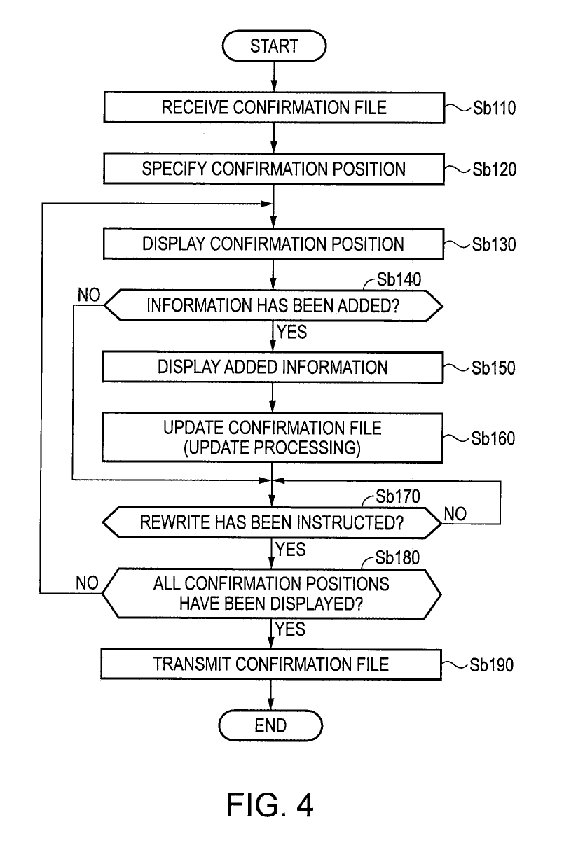

FIG. 4 is a flowchart showing operations performed by the display terminal 100b of the user “b”. The operations are started by the display terminal 100b receiving the confirmation file transmitted from the display terminal 100a, which is realized by the control unit 110 of the display terminal 100b executing a certain program. Accordingly, first, the display terminal 100b receives the confirmation file transmitted by the display terminal 100a (Step Sb110). At this time, the display terminal 100b acquires the confirmation file through the communication unit 150 and stores the file in the storage unit 120.

Next, the display terminal 100b displays the content corresponding to the received confirmation file on the display unit 130. The operation may be performed at a point when the user “b” performs the operation of instructing display of the content or the content corresponding to the confirmation file may be displayed by suspending display of another content browsed by the user “b” at that time. In the latter case, it is preferable that display for confirming the display of the content is performed by a pop-up window and the like to provide a stage for prompting agreement of the user “b”. The display terminal 100b performs processing of preferentially displaying the position whose confirmation is requested by the user “a”, namely, the confirmation position when displaying the content corresponding to the confirmation file. The processing is specifically performed as follows.

The display terminal 100b reads the confirmation file stored in the storage unit 120 and specifies the position designated by the user “a”, namely, the confirmation position corresponding to the confirmation file in the content (Step Sb120). The display terminal 100b, when specifying the position associated with the confirmation file, displays the specified confirmation position on the display unit 130 (Step Sb130). At this time, when one position is specified as the confirmation position, the display terminal 100b displays that position, and when plural confirmation positions are specified, positions not displayed of these positions are displayed in the prescribed order.

In the display, when the specified confirmation position is a certain page of the content, the display terminal 100b displays the page, and when the specified confirmation position is an arbitrary position in the content, the display terminal 100b performs display so that the position is included in the display area. At this time, it is preferable that the display terminal 100b performs display so that the specified confirmation position is in the center of the display surface or so that the specified confirmation position is in an upper end (in the case of horizontal writing) or in a right end (in the case of vertical writing).

When the confirmation position designated by the user “a” is displayed, the display terminal 100b is in the state of accepting addition of information by the user “b”. That is, the display terminal 100b repeatedly determines whether information is added by the user “b” or not (Step Sb140), and when information is added (YES: Step Sb140), displays the added information on the display unit 130 and executes update processing of updating the confirmation file (Step Sb150, Sb160).

As information to be added by the user “b”, there exist prescribed images which are previously prepared in addition to the handwriting image. The prescribed images are, for example, an image of characters indicating that the user “b” has made confirmation or agreement such as “OK”, an image resembling a so-called sticky note and the like. When such images are added, it is preferable that the display terminal 100b includes the operation element 141 for that. Hereinafter, these images are generically named an “additional image”. The additional image is an image associated with a position designated by the user “b”.

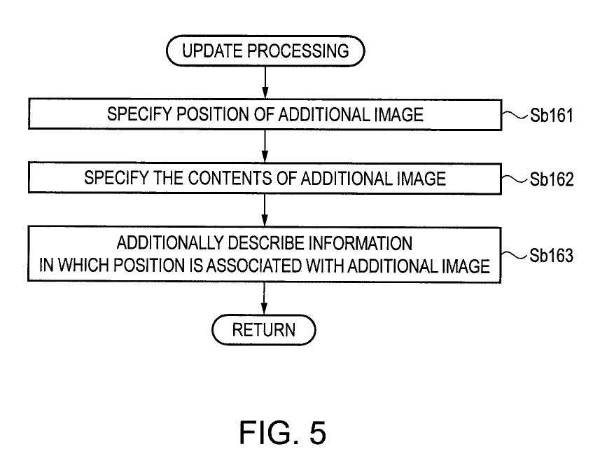

FIG. 5 is a flowchart showing update processing. The display terminal 100b specifies the position of the additional image added by the user “b” (Step Sb161), and further, specifies the contents of the additional image (Step Sb162). Specifically, the display terminal 100b specifies which additional image has been added to which position in the content at this time. The display terminal 100b updates the confirmation file by additionally describing information in which the specified position is associated with the additional image (Step Sb163). That is, in the updated confirmation file, the position added by the user “b” and the additional image are described by being associated with each other in addition to the position designated by the user “a”.

When the update processing has been completed or when the addition of information by the user “b” has not been performed, the display terminal 100b determines whether rewrite has been instructed by the user “b” or not (Step Sb170). The display terminal 100b, when acquiring operation information indicating rewrite of the display area (YES: Step Sb170), determines whether there is any confirmation position specified in Step Sb120 which has not been displayed or not (Step Sb 180), and when there is a confirmation position which has not been displayed (No: Step Sb180), repeats the processing after Step Sb130. When all confirmation positions specified in Step Sb120 have been displayed (YES: Step Sb180), the display terminal 100b outputs the confirmation file through the communication unit 150 and transmits the file to the display terminal 100a (Step Sb190).

Here, refer to FIG. 3 again. The display terminal 100a receives the confirmation file transmitted in Step Sb190 (Step Sa150). That is, the display terminal 100a acquires the confirmation file through the communication unit 150. The display terminal 100a specifies the position corresponding to the confirmation file in the content (Step Sa160) based on the acquired confirmation file and displays the specified position on the display portion 130 (Step Sa170). The operation is almost the same as the operation when the display terminal 100b performs preferential display, and when the additional image is associated with the confirmation position, the additional image is displayed with the content.

The display terminal 100a, when performing preferential display, it is preferable to preferentially display only the position newly added by the display terminal 100b, not preferentially display all positions associated with the confirmation file. This operation may be performed when the position additionally described by the user “b” is only the position where the confirmation is requested by the user “a”. When such operation is performed, it is preferable that the confirmation file includes information for identifying that the information of the position or the image has been added by which user.

In the information processing system 10 according to the embodiment, the following advantages can be obtained by the above operations. That is, it is possible that the user “a” designates the position which is especially required to be confirmed and prompts confirmation of the user “b”. It is also possible that the user “b” selectively browses only the position which is especially required to be confirmed in the content and additionally describes additional information such as a handwriting image and the like if necessary. It is further possible that the user “a” confirms what kind of addition has been performed by the user “b” at the position designated by the user “a”.

As described above, according to information processing system 10 of the embodiment, the confirmation of the required position in the content can be performed more rapidly and positively as compared with the case of confirming the whole contents fully, which enables actions such as a work of browsing the contents to be executed more efficiently. The information processing system 10 according to the embodiment is particularly advantageous in the case that the amount (number of pages) of the content is enormous or there exist many contents.

### Second Embodiment

The present embodiment differs from the above First Embodiment in a form of additional information, however, the configuration of the display terminal 100 and the like are the same as First Embodiment. Therefore, in the embodiment, a point different from First Embodiment will be chiefly explained. Concerning matters which are common to First Embodiment, explanation thereof is appropriately omitted.

The additional information according to the embodiment is different from the above confirmation file, which corresponds to so-called link. The additional information according to the embodiment displays characters or an image for displaying the confirmation position on the display unit 130, and a user confirms any of confirmation positions by selecting the characters or the image. In the following, additional information according to the invention is referred to as a “link file” and characters or the image for displaying the confirmation position is referred to as a “link image”.

The link file includes information indicating the link image and information of specifying the confirmation position to be displayed when the link image is selected. When the link image corresponds to characters or signs, the link file includes character codes indicating the characters or signs, and when the link image corresponds to an image, the link file includes image data indicating the image.

The link file can also include an additional image. That is, when additional image is added by the user, image data indicating the additional image and information indicating the position are written in the link file.

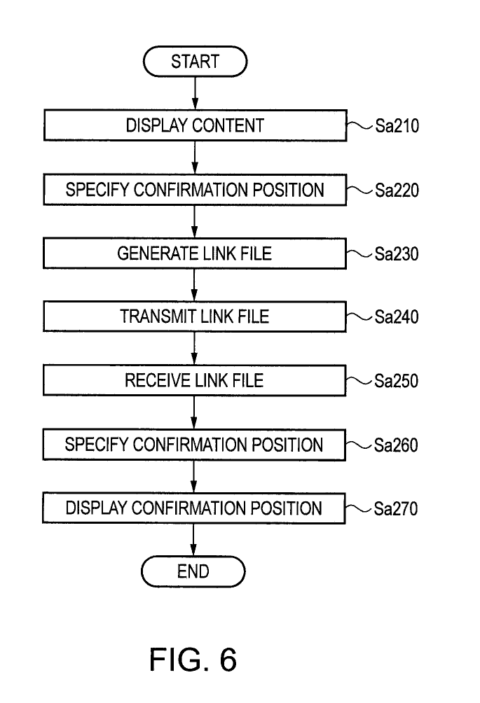

FIG. 6 is a flowchart showing operations performed by the display terminal 100a of the user “a”. As shown in the drawing, first, the display terminal 100a reads content data desired by the user “a”, displaying a content corresponding to the data on the display unit 130 (Step Sa210). The user “a” performs operation of designating a position which is requested to be confirmed by the user “b” while browsing the content. The display terminal 100a accepts the operation and specifies the position designated by the user “a”, namely, the confirmation position (Step Sa220).

The display terminal 100a, when specifying the confirmation position designated by the user “a”, generates data in which the confirmation position is described, namely, a link file (Step Sa230). In the link file, information such as a page or coordinates for specifying the confirmation position designated by the user “a” is described in the same manner as the confirmation file. After that, the display terminal 100a, when a prescribed operation indicating transmission of the link file, outputs the link file through the communication unit 150 and transmits the file to the display terminal 100b (StepSa240).

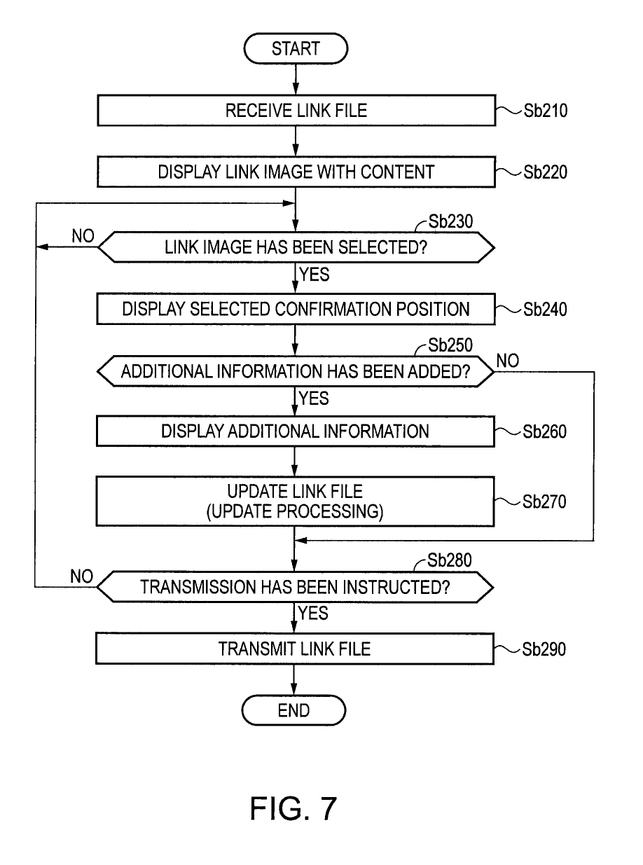

FIG. 7 is a flowchart showing operations performed by the display terminal 100b of the user “b” after receiving the link file. As shown in the drawing, the display terminal 100b, first, receives the link file transmitted by the display terminal 100a (Step Sb210). The display terminal 100b, when acquiring the link file, displays the link image described in the link file on the display unit 130 with the corresponding content (Step Sb220).

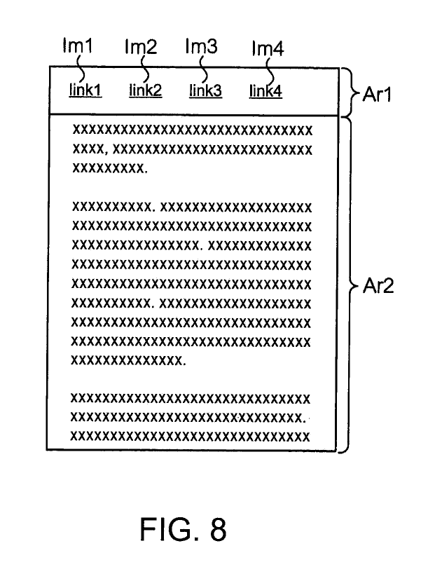

FIG. 8 is a view illustrating display of the link image by the display unit 130. The display unit 130 divides the whole display surface into a link display area Ar1 and a content display area Ar2, displaying link images in the link display area Ar1 and displaying the content in the content display area Ar2 respectively. In the example shown in the drawing, there exist four confirmation positions and link images Im1 to Im4 corresponding to first to fourth confirmation positions are displayed in the link display area Ar1.

The user “b” instructs display of the confirmation position by selecting a desired link image. The selection of the link image is performed by the prescribed operation element 141 or the touch screen 142. The display terminal 100b determines whether operation information indicating the selection of the link image has been supplied or not while performing display as shown in FIG. 8 to thereby determine which link image has been selected repeatedly (Step Sb230). Then, the display terminal 100b, when any of link images has been selected (YES: Step Sb230), displays the confirmation position associated with the selected link image (Step Sb240) on the display unit 130.

The display terminal 100b determines whether additional information has been added by the user “b” or not repeatedly (Step Sb250), and when information has been added (YES: Step Sb250), the display terminal 100b displays added information on the display unit 130 and performs update processing updating the link file (Step Sb260, Sb270). The processing from Step Sb250 to Sb270 is the same as processing from Step Sb140 to Sb160 in First Embodiment except that an update target is the link file.

After the update processing has been completed, the display terminal 100b waits for an instruction of transmitting the link file (Step Sb280). The instruction is performed by the user “b” performing a prescribed operation, and the display terminal 100b determines whether operation information corresponding to the operation is supplied or not. The display terminal 100b, when the transmission of the link file is instructed (YES: Step Sb280), transmits the link file to the display terminal 100a (Step Sb290), and when the instruction is not performed (NO: Step Sb280), the display terminal 100b executes the processing after Step Sb230, repeating the operation of displaying the confirmation position when the link image is selected. The display terminal 100b repeats the same operation until the transmission of the link file is instructed.

Here, refer to FIG. 6 again. The display terminal 100a receives the link file transmitted in Step Sb290 (Step Sa250). The display terminal 100a specifies a position associated with the link file in the content based on the acquired link file (Step Sa260), displaying the specified position on the display unit 130 (Step Sa270). The processing from Step Sa250 to Sa270 is the same as the processing from Step Sa150 to Sa 170 of First Embodiment except a point that the processing target is the link file.

In the information processing system 10 according to the embodiment, the same advantages as First Embodiment can be obtained by performing the above operations. According to the information processing system 10 of the embodiment, it is possible to display confirmation positions in the arbitrary order, not in the prescribed order as First Embodiment.

### Modification Examples

The invention is not limited to the above embodiments and can be realized in other embodiments. For example, the following modifications can be applied to the invention. The respective modification examples shown below can be appropriately combined with one another if necessary.

### 1. Modification Example 1

There are examples in which both a content and additional image are displayed. For example, it is preferable that the additional image added by the user is displayed in the same manner as added by the user even in another user, or the converse manner can exist. As an example of the former case, an example of superimposing an additional image on the content to be displayed can be cited and as an example of the latter case, an example in which the display area of the content and the display area of additional image are separated can be cited.

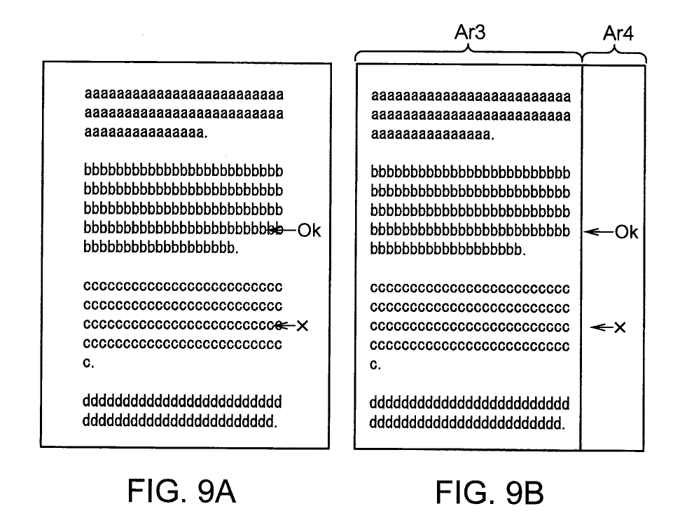

FIG. 9A and FIG. 9B are views illustrating modes of displaying both a content and an additional image. FIG. 9A corresponds to the former case and FIG. 9B corresponds to the latter case. These drawings both show cases in which the same additional image is added. FIG. 9A shows a handwriting image as a certain user (user “b”) has written and displayed in the same manner for another user (user “a”). On the other hand, FIG. 9B is an example in which the image is displayed for a certain user (user “b”) as it has been written, that is, as shown in FIG. 9A, however, the image is displayed in another mode for another user (user “a”). In FIG. 9B, the display surface is divided into a content display area Ar3 and an additional image display area Ar4. In the case of performing such display, the display terminal 100 rewrites the additional image display area Ar4 in the same manner when rewriting the content display area Ar3, and moves by an equal amount. That is, the display terminal 100 rewrites display so that correspondence between the content display area Ar3 and the additional image display area Ar4 is maintained.

### 2. Modification Example 2

In the above embodiments, it is preferable that the same function as the display terminal 100b is given to the display terminal 100a or the same function as the display terminal 100a is given to the display terminal 100b. In addition, a configuration may be applied, in which only the processing from the designation of the confirmation position to the transmission (to Step Sa140 or Step Sa240) is performed in the display terminal 100a and the confirmation after that is not performed.

### 3. Modification Example 3

A display device according to an embodiment of the invention may have both functions of the display terminal 100 and the communication terminal 200. That is, the display device according to an embodiment of the invention can apply a configuration in which the device itself has a transmission unit and a reception unit for communicating with a network. It is also possible to apply a configuration in which the transmission unit and the reception unit perform communication directly with another display device by a short-distance wireless communication, instead of the configuration in which they perform communication with the network.

### 4. Modification Example 4

A display device according to an embodiment of the invention does not always have to take a form of the electronic paper. The display device according to an embodiment of the invention may have a form such as a personal computer or a PDA (Personal Digital Assistant) if it has a configuration capable of generating additional information by designating the confirmation position, outputting the information and performing preferential display by acquiring the additional information. Concerning a configuration for inputting the additional image, it is possible to use a mouse or a keyboard, not limited to the operation element 141 and the touch screen 142.

### 5. Modification Example 5

A display device according to an embodiment of the invention is capable of rewriting display of the content and displaying an arbitrary position desired by the user as well as performing preferential display of the confirmation position. The display device according to an embodiment of the invention may have a configuration of executing these two kinds of displays selectively when performing display of them. For example, the display device according to an embodiment of the invention may have a configuration in which a mode of displaying an arbitrary position desired by the user and a mode of displaying confirmation positions sequentially according to an instruction by the user and the device is operated in the mode selected by the user after determining which mode has been selected.

### 6. Modification Example 6

A display device according to an embodiment of the invention may have a configuration in which functions realized by the display terminal 100a and the display terminal 100b are realized by a single device. For example, the display device according to an embodiment of the invention can provide a user identifying unit for identifying a user relating to use, and when the user relating to use is identified as a user on the side of designating the confirmation position, namely, the user corresponding to the above-described user “a”, operations corresponding to the display terminal 100a can be performed, and when the user relating to use is a user on the side of confirming the confirmation position or performing additional description such as a handwriting image, namely, the user corresponding to the above-described user “b”, operations (preferential display and the like) corresponding to the display terminal 100b can be performed.

As a configuration of the above user identifying unit, various well-known authentication means can be applied. For example, it is possible to identify the user by inputting an ID or a password, or it is also possible to identify the user by biometrics authentication using finger prints or a iris pattern.

### 7. Modification Example 7

A display device according to an embodiment of the invention may have a configuration in which additional information is transmitted to a predetermined destination. In the case of such configuration, the display device according to an embodiment of the invention includes a means for acquiring information of specifying an destination, namely, an external device to which additional information is transmitted (hereinafter, referred to as “destination information”) and transmitting additional information based on the destination information. The destination information is information associated with additional information, which is transmitted from, for example, an external device in a state of being included in additional information. It is also preferable that the destination information is previously stored in the display device. In this case, destination is identification information assigned to respective display devices. The destination is written by, for example, an e-mail address when additional information is transmitted or received by e-mail.

It is also preferable that the destination information has a configuration of realizing a circular of the content by plural users. The destination information may describe the destination, for example, in a manner in which, when a certain user confirms a certain content, the user transmits additional information to another user, and when another user confirms the content, the another user transmits additional information to further another user. In this case, the display device specifies a destination corresponding to the device itself and specifies a destination corresponding to a display device to which additional information is transmitted from the device itself.

### 8. Modification Example 8

In the embodiments of the invention, content data may be transmitted or received with additional information. In this case, the additional information may be included in content data. According to this configuration, it is not necessary that the display device on the side of confirming the content stores content data in advance.

Also, according to an embodiment of the invention, a link image can apply various display modes which are preferable for specifying a confirmation position. For example, the link image may be a page number of a confirmation position or additional information itself is a link image.

### 9. Modification Example 9

In the embodiments of the invention, particularly, display control by a display device, that is, the control executed by the control unit 110 of the display terminal 100 has features. Therefore, embodiments of the invention can be specified as a display control device performing the display control.

Since the display control is realized by executing a program, embodiments of the invention can be specified as a program or a recording medium which records the program. The program can be provided by being downloaded from a prescribed server device to a computer through a network to be made available by being installed.

Japanese Patent Application No. 2007-323631 filed on Dec. 14, 2007, is hereby incorporated by reference in its entirety.

What is claimed is:

1. An information processing method, comprising:
generating additional information associated with a predetermined position in a content to be displayed;
storing content data indicating the content;
specifying the position in the content, which is associated with the additional information;
displaying the content indicated by the stored content data;
controlling display so that a display area including the specified position is displayed in preference to other display areas in the display of the content;
adding an additional image which is an image different from the content, and which is displayed by being associated with a certain position in the content; and
performing update of the additional information, which is the update of allowing information indicating the added additional image and the position associated with the additional image to be included in the additional information.

2. An information processing system, comprising:
a generating unit that generates additional information associated with a predetermined position in a content to be displayed;
a storage unit that stores content data indicating the content;
a specifying unit that specifies the position in the content, which is associated with the additional information generated by the generating unit;
a display unit that displays the content indicated by the content data stored in the storage unit;
a display control unit that controls display by the display unit so that a display area including the position specified by the specifying unit is displayed in preference to other display areas in the display of the content;
an adding unit that adds an additional image which is an image different from the content, and which is displayed by being associated with a certain position in the content; and
an update unit that performs update of the additional information generated by the generating unit, which is the update of allowing information indicating the additional image added by the adding unit and the position associated with the additional image to be included in the additional information.

3. The information processing system according to claim 2,
wherein the display control unit displays the additional image with the display area when there is the additional image associated with the position in the case that the display area including the position specified by the specifying unit is displayed on the display unit.

4. The information processing system according to claim 3, further comprising:
an acceptance unit that accepts a handwriting image by a handwriting operation by a user, and
wherein the adding unit adds the handwriting image received by the acceptance unit as the additional image.

5. The information processing system according to claim 2, further comprising:
a first device and a second device, and
wherein the first device includes the generating unit and an output unit that outputs additional information generated by the generating unit, and
wherein the second device includes an acquisition unit that acquires additional information outputted by the output unit, the storage unit, the specifying unit, the display unit, the display control unit, the adding unit and the update unit.

6. The information processing system according to claim 2, further comprising:
a selection unit that selects a link image displayed on the display unit, and
wherein the display control unit displays the link image indicating a position specified by the specifying unit on the display unit, and displays a display area including the position on the display unit in preference to other display areas when the link image is selected by the selection unit.

7. The information processing system according to claim 2,
wherein the display control unit includes a determination unit that determines between a case of performing preferential display based on the additional information and a case of not performing the preferential display, and
wherein the display control unit controls the display unit so that a display area including a position specified by the specifying unit is displayed in preference to other display areas in the display of the content when it is determined that the preferential display is performed.

8. The information processing system according to claim 3,
wherein, in the case that there are plural positions specified by the specifying unit, when a position allows to be included in the additional information by the update unit in the plural positions, the display control unit displays a display area including the position in preference to other display areas.

9. The information processing system according to claim 2, further comprising:
a transmission unit that transmits additional information updated by the update unit to an external device.

10. The information processing system according to claim 9,
wherein the transmission unit performs transmission in accordance with destination information associated with the additional information and specifying the external device to which the information is transmitted.

11. The information processing system according to claim 2, further comprising:
a user identifying unit that identifies a user relating to use, and
wherein the display control unit, when the user identified by the user identifying unit is a prescribed user, a display area including the position specified by the specifying unit is displayed in preference to other display areas in the display of the content, and when the user identified by the user identifying unit is not the prescribed user, the content is displayed on the display unit in a manner different from the case that the user is the prescribed user.

12. A display control device, comprising:
a first acquisition unit that acquires content data indicating a content to be displayed;
a second acquisition unit that acquires additional information associated with a predetermined position in the content;
a specifying unit that specifies the position in the content, which is associated with additional information acquired by the second acquisition unit;
a display control unit that displays the content indicated by the content data acquired by the first acquisition unit on the display unit and that controls the display so that a display area including the position specified by the specifying unit is displayed in preference to other display areas in the display of the content;
an adding unit that adds an additional image which is an image different from the content, and which is displayed by being associated with a certain position in the content; and
an update unit that performs update of the additional information acquired by the second acquisition unit, which is the update of allowing information indicating the additional image added by the adding unit and the position associated with the additional image to be included in the additional information.
